(19) United States
(12) Patent Application Publication
(10) Pub. No.: US 2022/0383128 A1
(43) Pub. Date: Dec. 1, 2022

(54) IMAGE-BASED ANOMALY DETECTION BASED ON A MACHINE LEARNING ANALYSIS OF AN OBJECT

(71) Applicant: ZEBRA TECHNOLOGIES CORPORATION, Lincolnshire, IL (US)

(72) Inventors: Daniel S. Gonzales, Aurora, IL (US); Yan Zhang, Buffalo Grove, IL (US); Andrea Mirabile, London (GB); Alessandro Bay, London (GB)

(21) Appl. No.: 17/334,162

(22) Filed: May 28, 2021

(51) Int. Cl. G06N 3/08; G06N 20/10; G06N 5/04; G06N 3/04

(52) U.S. Cl. CPC G06N 3/088; G06N 20/10; G06N 5/04; G06N 3/0454

(57) ABSTRACT

An object analysis system is disclosed herein. The object analysis system may receive an input image that depicts an object. The object analysis system may determine, using a feature extraction model and from the input image, a first feature output that is associated with one or more features of the object. The feature extraction model may be trained based on reference images that depict reference objects that are a type of the object. The object analysis system may determine, using a classification model, that an anomaly status of the object is indicative of the object including an anomaly. The classification model may be trained based on the reference images. The object analysis system may determine, using an anomaly localization model, a location of the anomaly in the input image based on a second feature output of the convolutional neural network encoder. The anomaly localization model may be trained based on the reference images. The object analysis system may perform an action associated with the location of the anomaly.

### BACKGROUND

Quality control is a process that involves analyzing and/or reviewing a product to ensure that the product meets certain quality standards and/or criteria. For physical products, a visual inspection of the product may be required to identify an anomaly on or associated with the product that would prevent the product from meeting the certain quality standards and/or criteria. Forms of such an anomaly may be dependent on the type of product and/or unique with respect to having various characteristics. Therefore, there is a need for a system that is capable of detecting unique anomalies on or associated with a certain product.

### SUMMARY

In some implementations, a method associated with detecting an anomaly associated with an object includes receiving an input image that depicts the object; processing, using a feature extraction model, the input image to indicate one or more features of the object in a first feature output, wherein the feature extraction model is trained based on reference images associated with a type of the object, wherein the reference images depict one or more non-anomalous objects that are of a same type as the type of the object; determining, based on the one or more features, using a classification model, that an anomaly status of the object indicates that the object includes an anomaly, wherein the classification model is configured to determine the anomaly status based on a classification score associated with the first feature output and a classification threshold of the classification model, wherein the classification threshold is determined based on a similarity analysis involving the reference images; determining a location of the anomaly associated with the anomaly status based on a second feature output of the feature extraction model, wherein the location of the anomaly is determined using an anomaly localization model that is trained based on the reference images; generating, based on the anomaly status and the location, anomaly data that is associated with the anomaly; and providing, to an object management system, the anomaly data.

In some implementations, a device includes one or more memories and one or more processors, coupled to the one or more memories, configured to: receive an input image that depicts an object; process, using a feature extraction model, the input image to generate a first feature output that is associated with one or more features of the object, wherein the feature extraction model is trained based on reference images associated with a type of the object; determine, using a classification model, an anomaly status of the object based on the first feature output, wherein the classification model is trained to determine the anomaly status based on a similarity analysis involving non-anomalous objects depicted in the reference images; determine, based on the anomaly status indicating that the input image depicts the object having an anomaly, a location of the anomaly in the input image based on a second feature output of the feature extraction model, wherein the location of the anomaly is determined using an anomaly localization model that is trained based on the reference images; generate, based on the anomaly status and the location, anomaly data that is associated with the anomaly; and perform an action associated with the anomaly data.

In some implementations, a tangible machine-readable medium storing a set of instructions includes one or more instructions that, when executed by one or more processors of a device, cause the device to: receive an input image that depicts an object; determine, using a convolutional neural network encoder and from the input image, a first feature output that is associated with one or more features of the object, wherein the convolutional neural network encoder is trained based on reference images that depict reference objects that are a type of the object; determine, using a support vector machine, that an anomaly status of the object is indicative of the object including an anomaly, wherein the support vector machine is trained based on the reference images; determine, using a convolutional neural network decoder, a location of the anomaly in the input image based on a second feature output of the convolutional neural network encoder, wherein the convolutional neural network decoder is configured to determine the location of the anomaly based on a second feature output of the convolutional neural network encoder, and wherein the convolutional neural network decoder is trained based on the reference images; and perform an action associated with the location of the anomaly.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate implementations of concepts disclosed herein, and explain various principles and advantages of those implementations.

FIG. 1 is a diagram of an example implementation associated with training a machine learning model of an object analysis system described herein.

FIG. 2 is a diagram of an example implementation associated with image-based anomaly detection involving an object analysis system described herein.

FIG. 3 is a diagram of an example implementation associated with a classification model described herein.

FIG. 4 is a diagram of an example implementation associated with an anomaly localization model described herein.

FIG. 5 is a diagram illustrating an example of training and using a machine learning model in connection with image-based anomaly detection.

FIG. 6 is a diagram of an example environment in which systems and/or methods described herein may be implemented.

FIG. 7 is a diagram of example components of one or more devices of FIG. 6.

FIG. 8 is a flowchart of an example process relating to an image-based anomaly detection based on a machine learning analysis of an object.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations described herein.

The apparatus and method elements have been represented where appropriate by conventional symbols in the drawings, showing only those specific details that are pertinent to understanding the implementations described herein so as not to obscure the disclosure with details that will be readily apparent to those of ordinary skill in the art having the benefit of the description herein.

### DETAILED DESCRIPTION

The following detailed description of example implementations refers to the accompanying drawings. The same reference numbers in different drawings may identify the same or similar elements.

Anomaly detection may be performed using an image-based analysis. For example, an image processing model (e.g., a computer vision model) may be trained to identify anomalies on an object, such as a product, equipment, a structure, or other type of physical object. The image processing model may be trained using images that depict objects that have anomalies (which may be referred to as “anomalous objects”), such as scratches, cracks, punctures, discolorations, missing elements, additional elements, or other types of anomalies. However, due to a variety of types of anomalies, a variety of characteristics (e.g., sizes, shapes, locations) of the individual types of anomalies, and/or an ability of the characteristics of the anomalies to change over time (e.g., due to unknown or unexpected changes in an environment), such an image processing model may be relatively inaccurate, thereby resulting in false negative or false positive detections of anomalies. For example, because the image processing model has not been trained to identify a particular type of anomaly and/or a particular characteristic of the anomaly, the image processing model may be incapable of accurately detecting that type of anomaly on an object. Therefore, there is a need for an object analysis system that can robustly and accurately detect unique anomalies and/or unknown anomalies on an object or associated with object.

Some implementations described herein provide an object analysis system for detecting, classifying, and/or locating an anomaly on an object. The object analysis system may include and/or utilize an arrangement of models that are trained based on reference images that depict one or more reference objects that do not include or have any anomalies. For example, the object analysis system may include a feature extraction model, a classification model, and an anomaly localization model that are configured to analyze an object to determine whether the object includes an anomaly. The models may be trained to identify, analyze, and/or detect features of a reference object from an analysis of the reference images that depict the one or more non-anomalous objects. In this way, the object analysis system may detect, classify, and/or locate the anomaly based on a comparison of the reference object and an object that is depicted in an input image (e.g., an image that depicts an object that is being analyzed by the object analysis system). In this way, without being trained using training images that depict a particular anomaly or a particular configuration of an anomaly, the object analysis system, as described herein, may robustly and accurately detect, classify, and/or locate an anomaly on an object. Furthermore, the models of the object analysis system may be trained using less training data than other systems, thereby conserving computing resources (e.g., processing resources, memory resources, and/or storage resources) while maintaining and/or improving image-based anomaly detection robustness and accuracy with respect to the other systems.

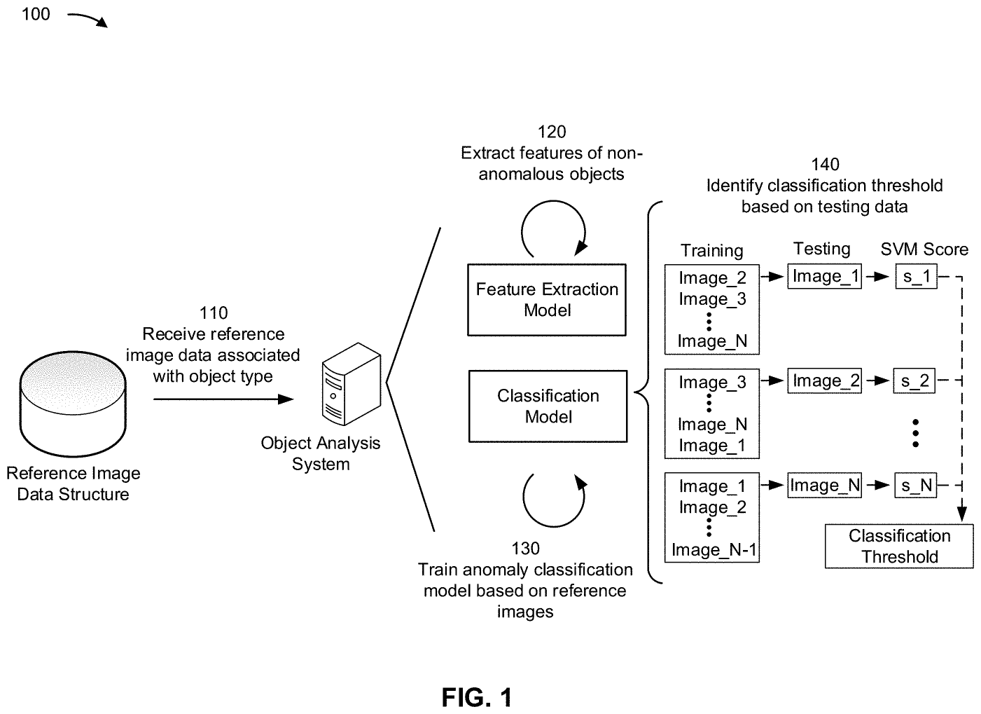

FIG. 1 is a diagram of an example implementation 100 associated with training a machine learning model of an object analysis system. As shown in FIG. 1, example implementation 100 includes a reference data structure and an operation management system that includes a feature extraction model and a classification model. In example implementation 100, the object analysis system may train the feature extraction model and the classification model to detect an anomaly on an object based on reference images that depict one or more objects. While example implementation 100 may be described in connection with training the feature extraction model and/or the classification model to detect and/or classify an anomaly on or associated with a particular type of object, examples described in connection with FIG. 1 may be similarly applied in connection with training the feature extraction model and/or the classification to detect and/or classify an anomaly on or associated with multiple types of objects.

As shown in FIG. 1, and by reference number 110, the object analysis system may receive reference image data associated with an object type. For example, the object analysis system may obtain the reference image data from the reference image data structure during a training period associated with training the feature extraction model and/or the classification model. The reference image data structure may include a storage device and/or a memory device that receives and/or stores reference images from one or more image sources (e.g., one or more image capture devices, one or more image databases, and/or one or more networks or systems). The reference image data may include reference images that depict a type of object (e.g., a type of object that is to be analyzed for anomaly detection by the object analysis system). In some implementations, the reference images may depict multiple types of objects (e.g., to permit the feature extraction model and/or the classification model to detect anomalies on multiple types of objects according to examples described herein).

As described herein, the reference images may depict non-anomalous objects in order to permit the feature extraction model to identify features of an object depicted in an image and/or classify the object as anomalous or non-anomalous, based on the identified features. A non-anomalous object may be an object that does not include an anomaly. For example, a non-anomalous object, as used herein, may be considered a normal object, a standard object, or an acceptable object relative to a standard (e.g., an industry standard) or tolerance (e.g., a design tolerance and/or a manufacturing tolerance).

As further shown in FIG. 1, and by reference number 120, the object analysis system extracts features of non-anomalous objects. The non-anomalous objects may be depicted in the reference images that depict reference objects that are a same type of object. For example, the object analysis system, via the feature extraction model, may analyze the reference image data (and/or reference images of the reference image data) to identify features of a type of object. More specifically, the object analysis system may analyze the reference image data to identify features of reference objects depicted in the image data. Such features may be a set of features that are commonly depicted in the reference images.

In some implementations, the feature extraction model may include and/or be associated with an image processing model that is trained to preprocess the reference images to identify and/or extract pixels of the reference images that are associated with and/or that depict the reference objects. For example, the image processing model may include and/or be associated with an object detection model, a segmentation model, an edge detection model, and/or other type of model that is configured to determine a bounding box associated with depictions of an object within the reference images. Accordingly, the image processing technique may remove any background and/or noise in the reference images, in order to improve an accuracy and efficiency of identifying features of the reference objects. In this way, the feature extraction model may be trained using only portions of reference images that include or indicate the features of the reference objects (e.g., to facilitate and/or improve unsupervised learning and/or unsupervised training of the feature extraction model).

The feature extraction model may include and/or be associated with a machine learning model that is trained (e.g., by the object analysis system and/or another system) and/or used as described elsewhere herein. For example, the object analysis system may train the feature extraction model to analyze a type of object based on the reference images of the reference image data being associated with the type of the object. In some implementations, the feature extraction model may be trained to identify the set of features in order to provide (e.g., as a first feature output from an output layer of the feature extraction model) the set of features to the classification model. In this way, the set of features may be used to train the classification model to determine whether an input image depicts an anomalous object or a non-anomalous object, as described elsewhere herein.

As further shown in FIG. 1, and by reference number 130, the object analysis system trains the classification model based on the reference images. For example, the object analysis system may train the classification model based on the set of features that are identified and/or extracted by the feature extraction model. The object analysis system may train the classification model to determine an anomaly status of an object depicted in an image. For example, the anomaly status may indicate whether the object is anomalous or non-anomalous (e.g., according to a binary classification technique). Additionally, or alternatively, the anomaly status may indicate, if an object includes an anomaly, a particular type of anomaly.

The classification model may include and/or be associated with a support vector machine. For example, the object analysis system (and/or another system) may train the support vector machine to determine and/or predict a similarity to the non-anomalous objects that are depicted in the reference images of the reference image data. More specifically, the classification model may determine, via the support vector machine, a classification score based on the set of features. Further, the classification model may be trained to compare the classification score to a threshold to determine whether an object depicted in an input image is an anomalous object or a non-anomalous object. In some implementations, the threshold may be a fixed threshold, such as a fixed value (e.g., within a fixed range) that is set regardless of the set of features learned from the reference image data. Additionally, or alternatively, the threshold may be a customized threshold that is specific to the set of features of one or more reference objects identified by the feature extraction model. Such a customized threshold may be further refined into one or more classification thresholds to account for relatively minor variations or deviations of features (e.g., variations or deviations that would not be considered anomalies according to a standard or tolerance) of the non-anomalous objects depicted in the reference images.

As further shown in FIG. 1, and by reference number 140, the object analysis system identifies a classification threshold based on testing data. For example, as shown in FIG. 1, sets of testing data and training data may be configured and/or arranged from the reference image data. More specifically, a first set of training data and testing data may include a first image (Image_1) as testing data from a set of N images that is compared, via a similarity analysis, to the remaining images (Image_2 through Image_N) that are used to train the classification model in a first iteration. From the similarity analysis, the classification model (e.g., via the support vector machine) may determine a first classification score (shown as a support vector machine (SVM) score of s_1) for the first set of training data and testing data. Similarly, a second set of training data and testing data may include a second image (Image_2) as testing data from the set of N images that is compared, via the similarity analysis, to the remaining images (Image_1, and Image_3 through Image_N) that are used to train the classification model in a second iteration. From the similarity analysis, the classification model (e.g., via the support vector machine) may determine a second classification score (shown as an SVM score of s_2) for the first set of training data and testing data, and so on. In this way, N classification scores can be obtained from N sets of testing data and training data to determine a classification threshold. For example, the classification threshold may be determined based on shifting an identified or learned threshold from training the classification model according to the set of features identified by the feature extraction model. In this way, based on a similarity analysis involving non-anomalous objects depicted in the reference images, the object analysis system (and/or another system) may train (or refine) the classification model to identify a classification threshold, to reduce errors or inaccuracies that may otherwise be caused by relatively minor variations or deviations of features of reference objects (e.g., negligible differences in shapes, sizes, colors, or configurations of features).

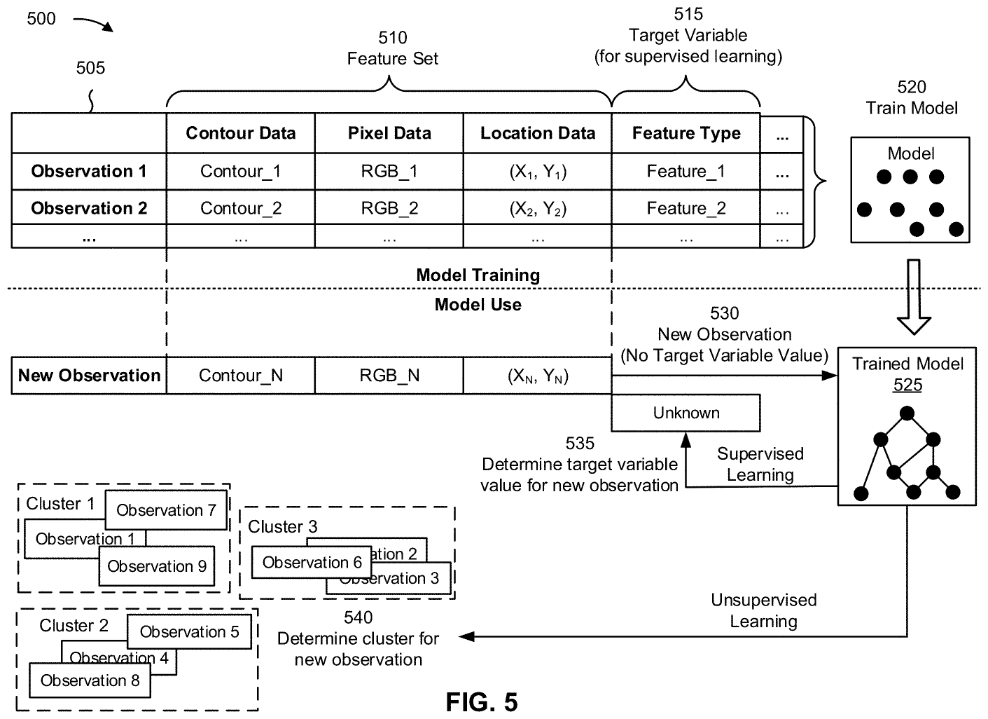

Accordingly, as described in connection with example implementation 100, the object analysis system (and/or another system) may train a feature extraction model and/or use the feature extraction model to train a classification model to determine an anomaly status of an object based on reference images that depict non-anomalous objects. In this way, the feature extraction model and classification model may coordinate to robustly and accurately detect various anomalies on an object without previously being trained to recognize the specific types of anomalies or the specific characteristics of the anomalies. The feature extraction model and/or the classification model may be trained according to any suitable techniques, as described in connection with FIG. 5.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

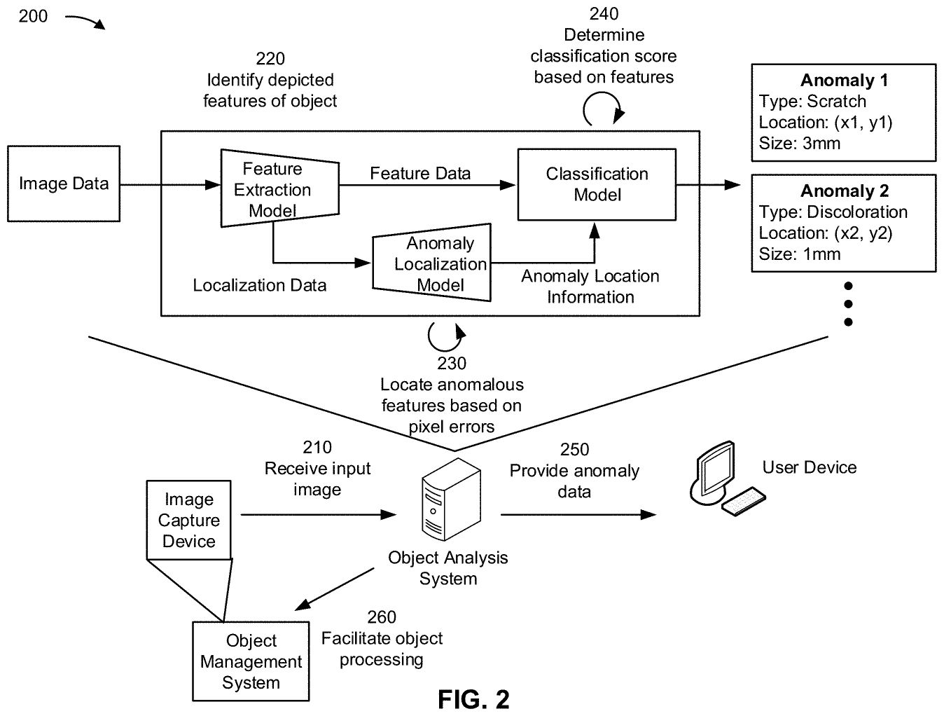

FIG. 2 is a diagram of an example implementation 200 associated with image-based anomaly detection involving an object analysis system. As shown in FIG. 2, example implementation 200 includes an object analysis system, an object management system, and a user device. In example implementation 200, the object analysis system includes a feature extraction model, a classification model, and an anomaly localization model.

The feature extraction model and/or the classification model may be trained in a similar manner as described above in connection with FIG. 1. In example implementation 200, the feature extraction model may include or be associated with a convolutional neural network encoder. Furthermore, the anomaly localization model may correspond to a decoder of a convolutional neural network. In this way, the feature extraction model and the anomaly localization model may be arranged as a convolutional neural network autoencoder, as described elsewhere herein. The classification model may include and/or be associated with one or more support vector machines, as described elsewhere herein.

In example implementation 200, the object management system may include and/or be associated with an image capture device (e.g., a camera) that is configured to capture and/or provide an image of an object, as described herein. The object management system may include an assembly or manufacturing system, an inventory management system, and/or a transportation system, among other examples. The object analysis system may be associated with the object management system in order to facilitate processing of an object based on whether the object analysis system detects an anomaly (or a particular type of anomaly) on the object. In some implementations, the object analysis system may be configured to indicate and/or identify patterns of detected anomalies, which may be indicative of an issue with one or more components or elements of the object management system (e.g., a faulty part of a manufacturing machine that is causing objects to include anomalies). Accordingly, the object analysis system may provide information to the object management system and/or the user device to permit the object management system and/or a user of the user device to process and/or manage an object (or the object management system) based on whether the object is determined to be an anomalous object.

As shown in FIG. 2, and by reference number 210, the object analysis system receives an input image. For example, the object analysis system may receive the input image from the image capture device. The image capture device may be configured and/or positioned within the object management system to facilitate image-based anomaly detection according to the examples described herein. In some implementations, the image capture device may be configured within the object management system in a same or similar position as one or more image capture devices that were used to capture the reference images described above in connection with training the feature extraction model and/or the classification model in example implementation 100. In this way, the input image may depict an object that is being processed by the object management system in a similar manner as the non-anomalous objects are depicted in the reference images described above.

As further shown in FIG. 2, and by reference number 220, the object analysis system identifies depicted features of the object. For example, as shown, the object analysis system, via the feature extraction model, may receive image data associated with the input image and identify object features from pixel values of the image data (e.g., pixel values that depict the object in the input image). The convolutional neural network encoder of the feature extraction model may be trained based on reference images that depict non-anomalous objects, as described elsewhere herein. In some implementations, the convolutional neural network encoder has multiple layers. For example, the convolutional neural network encoder may include an input layer that receives the image data, one or more intermediate layers that are trained to process the image data according to identified features depicted in the image, and an output layer that provides feature data, as a first feature output, to the classification model. In this way, the classification model may receive and/or identify a set of features that the feature extraction model identified in the input image to permit the classification model to determine an anomaly status of the object.

In some implementations, based on receiving the input image, the object analysis system may perform one or more preprocessing techniques on the image to facilitate the image-based anomaly detection, as described herein. For example, the object analysis system (e.g., via the feature extraction model), may utilize image processing model (e.g., a model that utilizes an object detection technique, a segmentation technique, and/or an edge detection technique) to locate an object depicted in the input image. More specifically, the preprocessing technique may identify a bounding box associated with the object that indicates a perimeter of the object based on a pixel-level analysis. Accordingly, pixels of the input image that depict the object can be extracted from pixels of the input image that do not depict a portion of the object (e.g., to remove background and/or noise from the input image). Additionally, or alternatively, the pixels that do not depict any portion of the object may be set to a fixed value (e.g., zero) so that the feature extraction model (or classification model or anomaly localization model) do not have to waste resources analyzing the pixels that do not depict a portion of the object. In this way, the image data in example implementation 200 may only include pixels that depict (or are associated with) the object so that the feature extraction model only analyzes pixels of the input image that a portion of the object.

The feature extraction model may provide localization data to the anomaly localization model. In some implementations, the feature extraction model provides (or enables the anomaly localization model to obtain) the localization data based on the anomaly localization model being triggered to determine a location of the anomaly (e.g., based on determining that object includes an anomaly). In this way, the feature extraction model may not provide localization data to the anomaly localization model until an anomaly is to be located, as described elsewhere herein.

The feature extraction model may provide localization data, as a second feature output, from an intermediate layer of the convolutional neural network encoder. Accordingly, the first feature output and the second feature output may be from different layers of a convolutional neural network (e.g., the convolutional neural network encoder) of the feature extraction model. The feature extraction model may be trained to output the localization data from an intermediate layer that detects a feature that is indicative of an anomaly and/or an intermediate layer that detects an unknown feature, such as a feature that was not learned during a training period of the feature extraction model and/or classification model. In this way, the feature extraction model may permit the anomaly localization model to determine, in parallel with the feature extraction model identifying additional features, a location of the anomaly. Accordingly, the anomaly localization model may indicate a location of the anomaly, as described elsewhere herein, relatively sooner than if the localization data were provided from the output layer (or the same as the feature data) and/or if the anomaly localization model was arranged in series between the feature extraction model and the classification model. In this way, because the classification model may not have to wait as long to receive location information associated with an anomaly, as described above, the object analysis system may detect and/or classify an anomaly according to a location of the anomaly, as described elsewhere herein, more quickly than if the anomaly localization model received the localization data from the output layer of the feature extraction model and/or if the anomaly localization model was in series between the feature extraction model and the classification model.

As further shown in FIG. 2, and by reference number 230, the object analysis system locates anomalous features based on pixel errors. For example, the anomaly localization model of the object analysis system may receive the pixel errors within localization data from the feature extraction model and locate the anomalous features according to the localization data. As mentioned above, the anomaly localization model may receive the localization data as a second feature output of the feature extraction model from a different layer than a first feature output of the feature extraction model that includes the feature data.

In some implementations, the anomaly localization model may be triggered (e.g., by the classification model) to determine a location of an anomaly and/or obtain the localization data after the classification model detects that the input image depicts an anomalous object. In such a case, the anomaly localization model may not receive or obtain the localization data until the classification model detects an anomaly on an object and/or determines that the input image depicts an anomalous object (e.g., according to a binary classification technique). In this way, the anomaly localization model may not process localization data from the feature extraction model until an anomaly is detected by the classification model, thereby conserving computing resources that would otherwise be wasted by attempting to locate an anomaly (that does not exist) in an input image that depicts a non-anomalous image.

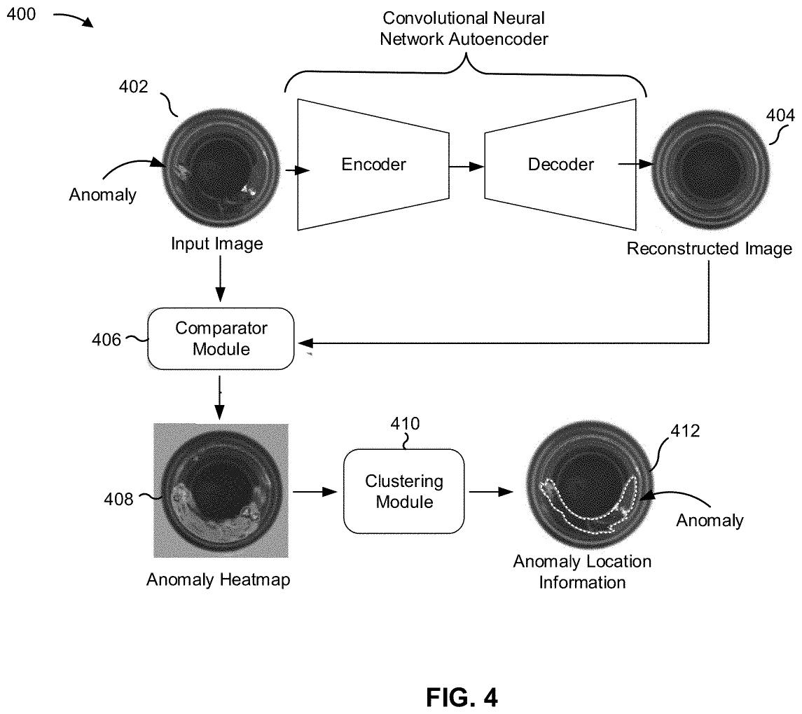

The convolutional neural network decoder of the anomaly localization model may be trained based on reference images that depict non-anomalous objects. For example, the anomaly localization model may be trained in a similar manner as the feature extraction model, as described elsewhere herein. The pixel errors may be determined based on a similarity analysis (e.g., using a structural similarity index measure (SSIM) per identified pixel error) involving the input image and a reconstructed image of the object from the localization data. For example, the reconstructed image may be representative of pixel values that correspond to a depiction of a non-anomalous object. Accordingly, based on the anomaly localization model determining a confidence level associated with pixel values of the input image (and/or localization data) corresponding to pixel values of the reconstructed image (e.g., are not within a designated range of values of the pixel values), the anomaly localization model may identify the location of an anomaly on the object (e.g., as further described at least in connection with FIG. 4).

The anomaly localization model may indicate the location within anomaly location information. For example, the anomaly location information may identify coordinates of the image and/or location information that is relative to the object (e.g., using directional identifiers, such as upper portion, lower portion, middle portion, left portion, right portion, and/or using surface identifiers, such as top surface, side surface, bottom surface, and so on). In some implementations, the anomaly localization model may determine a size of an anomaly based on a quantity of pixel errors, a quantity of pixels in a cluster determined from the pixel errors (e.g., a group of pixels that are within an area or boundary formed by identified pixel errors), and/or the coordinates of the image that include the pixel errors. The anomaly localization model may indicate, to the classification model, the size of the anomaly within the anomaly location information. In this way, the object analysis system, using the anomaly localization model, may determine and/or indicate a location of an anomaly to the support vector machine.

As further shown in FIG. 2, and by reference number 240, the object analysis system determines a classification score based on the features. For example, the classification model of the object analysis system may receive the feature data and/or the anomaly location information and determine a classification score that is indicative of an anomaly status of the object based on the feature data and/or the anomaly location information. In some implementations, the classification model may determine a classification score (e.g., via a support vector machine) based on a first feature output of the feature extraction model (e.g., the feature data from the output layer of the convolutional neural network encoder).

As mentioned above, the classification model may include or be associated with a support vector machine that is configured to provide the classification score that is indicative of the anomaly status. In some implementations, the support vector machine of the classification model may be a single class support vector machine that is specifically trained to analyze the type of the object depicted in the input image, as described elsewhere herein. The anomaly status may indicate whether the input image depicts the object having an anomaly based on the classification score being indicative of the object including an anomalous feature. The anomaly status may be determined and/or indicated based on a comparison of the classification score and a classification threshold (e.g., a threshold that is associated with whether an anomalous feature is indicative of an anomaly or is not indicative of an anomaly). In such a case, the classification model may output a binary classification according to the classification threshold (based on whether the classification score satisfies or does not satisfy the classification threshold). Accordingly, the anomaly status may indicate whether the object includes an anomalous feature or does not include an anomalous feature. In some implementations, if the object includes an anomalous feature, the anomaly status may indicate certain characteristics of an anomaly associated with the anomalous feature (e.g., type, location, and/or size, among other examples).

In some implementations, the anomaly localization model may provide a binary classification (e.g., indicating whether the object is anomalous or non-anomalous) to the classification model. In this way, the classification model may combine the binary classification from the anomaly localization model with a support vector machine classification (e.g., a binary classification from the support vector machine) of the classification model to verify that the classification score accurately is indicative of the object being anomalous or non-anomalous. Accordingly, the anomaly localization model may improve confidence and/or accuracy with respect to detecting (or predicting) whether an object has an anomaly. In some implementations, if a binary classification from the anomaly localization model does not verify or validate the support vector machine classification of the classification model (or vice versa), the object analysis system may indicate (e.g. to the user device and/or the object management system) that further processing is required. Additionally, or alternatively, the object analysis system may request or obtain another input image that depicts the object (and perform an analysis based on the other input image), and/or may cause the object management system to reconfigure the object prior to requesting or obtaining another image that depicts the object.

In FIG. 2, the classification model may utilize multiple support vector machines to classify identified anomalies on the object. For example, the classification model may include a first support vector machine that is trained to determine a binary classification (e.g., according to a first classification threshold) that is indicative of whether the object includes an anomaly or does not include an anomaly, a second support vector machine that is trained to determine a binary classification (e.g., according to a second classification threshold) that is indicative of whether an identified anomaly is a scratch or is not a scratch, and third support vector machine that is trained to determine a binary classification (e.g., according to a third classification threshold) that is indicative of whether the anomaly is a discoloration or is not a discoloration, among other examples. Accordingly, as shown, the classification model, via the first support vector machine, may generate anomaly data that indicates that the object includes an anomaly and/or that two identified features of the object correspond to two anomalies (Anomaly 1 and Anomaly 2). Furthermore, as shown, the classification model, via the second support vector machine, may generate anomaly data that indicates that a first anomaly (Anomaly 1) is a scratch. Moreover, the classification model, via the third support vector machine, may generate anomaly data that indicates that a second anomaly (Anomaly 2) is a discoloration.

In some implementations, as shown, the object analysis system may combine the anomaly location information with the anomaly classification to generate the anomaly data. For example, as shown, the anomaly data for the first anomaly may indicate that a scratch is located on the object as depicted at coordinates (x1, y1) and has a size of 3 millimeters. Further, the anomaly data for the second anomaly may indicate that a discoloration is located on the object as depicted at coordinates (x2, y2) and has a size of 1 millimeter. In some implementations, as described elsewhere herein, the anomaly data may be combined with the input image to indicate the location of an anomaly and/or the type of the anomaly. For example, the object analysis system may generate a location indicator (e.g., a highlight, an outline, an arrow, and/or an overlay, among other examples) that indicates the location of an anomaly on the object as depicted in the input image, by overlaying the location indicator on the input image and/or or embedding the location indicator within the input image.

As further shown in FIG. 2, and by reference number 250, the object analysis system provides anomaly data to the user device. For example, the object analysis system may provide a notification to the user device that includes the anomaly data and/or that alerts (e.g., via a prompt or message indicator) a user of the user device that an object includes an anomaly (e.g., to permit the user to identify and/or address the object within the object management system). In some implementations, the object analysis system may generate a report based on the anomaly data. For example, the report may be associated with a period of time or a batch of objects that the object analysis system analyzed, as described herein. In some implementations, the report may indicate statistics associated with detected anomalies (e.g., a quantity of objects that were determined to include anomalies, a quantity of certain types of anomalies, a pattern or trend associated with certain characteristics of anomalies, and/or the like). In some implementations, the object analysis system may provide the anomaly data to the user device based on detecting that the object includes an anomaly, based on detecting that a threshold quantity of analyzed objects during a certain time period include an anomaly, based on detecting that a threshold percentage of analyzed objects during a certain time period include an anomaly, and/or based on detecting a certain trend associated with a particular characteristic of an anomaly on objects has developed over a certain time period (e.g., multiple objects are determined to have a same or similar anomaly, which may be indicative of an issue with one or more components of the object management system causing the anomalies).

As further shown in FIG. 2, and by reference number 260, the object analysis system facilitates object processing. For example, the object analysis system may provide the anomaly data to the object management system to cause the object management system to manage the object. More specifically, the object analysis system may provide the anomaly data to the object management system to cause the object management system to control one or more devices to manage the object according to one or more operations. For example, such an operation may include discarding the object (e.g., by removing the object from processing), labeling the object as anomalous (e.g., via a labeling mechanism of the object analysis system), and/or routing the object to an area designated for anomalous objects (e.g., an area where the anomalous objects can be further inspected and/or repaired), among other examples. In some implementations, the object analysis system may control, according to the anomaly data, the object management system to perform one or more operations associated with the object.

In this way, the object analysis system may utilize a robust and accurate image-based anomaly detection model to facilitate management and/or processing of objects and ensure that analyzed objects satisfy certain criteria or standards (e.g., are non-anomalous objects) before the objects are output from the object management system, used in the field, and/or sold to consumers, thereby reducing or preventing a likelihood of a hazard or a degraded consumer experience from objects that do not satisfy the certain criteria or standards (e.g., anomalous objects).

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

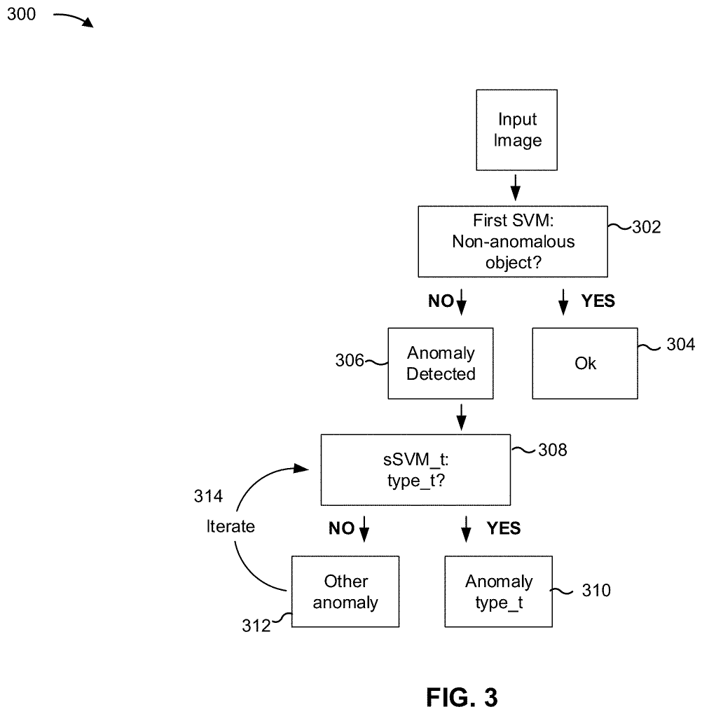

FIG. 3 is a diagram of an example implementation associated with a classification model described herein. As shown in FIG. 3, an example implementation includes an example of an arrangement of support vector machines that may be included within, utilized by, and/or trained in association with a classification model described elsewhere herein. The arrangement may include a cascade 300 of multiple support vector machines, including a first support vector machine and subsequent support vector machines (sSVM_t) for various types (t) of anomalies. The first support vector machine and subsequent support vector machines may be individual single class support vector machines that are independently trained for a specific purpose. More specifically, the first support vector machine may be trained to provide a binary classification of whether a received input image includes an anomaly or does not include an anomaly. Thresholds of the support vector machines may vary and may be determined according to the reference images of non-anomalous objects, as described elsewhere herein. Further, the individual subsequent support vector machines in the cascade 300 may provide a binary classification that is indicative of whether the anomaly is a corresponding type of anomaly that the individual subsequent support vector machines are trained to detect.

Accordingly, as shown by reference number 302, the first support vector machine may analyze an input image to determine whether the input image depicts a non-anomalous object. If the first support vector machine determines that the input image depicts a non-anomalous object, the first support vector machine indicates that the object is “Ok” (e.g., which may be representative of non-anomalous), as shown by reference number 304. If the first support vector machine determines that the input image depicts an anomalous object, the first support vector machine may indicate that an anomaly has been detected, as shown by reference number 306. Furthermore, as shown by reference number 308, in a first iteration, a subsequent support vector machine determines whether the detected anomaly corresponds to a particular type of anomaly. If the subsequent support vector machine determines that the anomaly is a particular type of anomaly, the particular type may be indicated, as shown by reference number 310. If the subsequent support vector machine determines that the anomaly is not the particular type of anomaly that the subsequent support vector machine is trained to identify, the cascade determines whether to check for another anomaly, as shown by reference number 312. If the subsequent support vector machine is the last support vector machine in the cascade, the classification analysis may end. Otherwise, as shown by reference number 314, the classification model iterates the analysis with another subsequent support vector machine that is trained to determine whether the anomaly is another type of anomaly, and so on.

The subsequent support vector machines can be arranged within the cascade in any suitable manner. For example, a most frequently detected type of anomaly may be positioned within the cascade nearest the first support vector machine (e.g., to reduce the likelihood of requiring multiple iterations through the cascade). Additionally, or alternatively, a simplest or least complex support vector machine (e.g., which may be configured to identify anomalies that are easiest amongst the support vector machines to detect) may be positioned within the cascade nearest the first support vector machine (e.g., to ensure that the anomaly is analyzed for the most easily detectable anomalies first, which may require relatively less processing power).

Accordingly, as shown in FIG. 3, a first support vector machine may be configured within a cascade to output a first binary classification that is indicative of the object including an anomalous feature. Furthermore, a second support vector machine (e.g., one of the subsequent support vector machines) may be configured to output, based on the first binary classification indicating that the object includes an anomalous feature, a second binary classification that indicates that the anomaly is a particular type of anomaly or that the anomaly is not the particular type of anomaly. Correspondingly, the classification model may generate anomaly data that includes, based on the second binary classification, a label that indicates that the anomaly is the particular type of anomaly or that the anomaly is not the particular type of anomaly.

As indicated above, FIG. 3 is provided as an example. Other examples may differ from what is described with regard to FIG. 3.

FIG. 4 is a diagram of an example implementation associated with an anomaly localization model 400. As shown in FIG. 4, the anomaly localization model 400 includes a convolutional neural network autoencoder that includes an encoder (e.g., corresponding to the convolutional neural network encoder described in connection with a feature extraction model described above) and a decoder (e.g., corresponding to the convolutional neural network decoder described in connection with the anomaly localization model above) that are trained according to examples described elsewhere herein. Furthermore, the anomaly localization model 400 incudes a comparator module, a classifier module, and a clustering module.

As shown, at reference number 402, the convolutional neural network autoencoder receives an input image. The input image is shown to include an anomaly. The encoder identifies features in the input image that are provided to the decoder. The decoder, based on the features, generates a reconstructed image of a reference object (e.g., representative of a type of object that the convolutional autoencoder is trained to identify), as shown at reference number 404. At reference number 406, the comparator module compares the input image and the reconstructed image (e.g., using an SSIM per pixel error analysis). Based on a comparison of the pixel values (and/or a confidence level that pixel values of pixels of the input image correspond to pixel values of corresponding pixels of the reconstructed image), pixel errors can be detected that may be indicative of an anomaly, and/or locations of the pixel errors may correspond to locations of the anomaly. The comparator module may generate an anomaly heatmap at reference number 408, which may be used to indicate a location of the anomaly. Additionally, or alternatively, at reference number 410, the clustering module may perform a clustering technique (e.g., a k-means clustering) to determine an area and/or perimeter of the anomaly that is to be included or indicated in the anomaly location information, as shown at reference number 412. In this way, the anomaly localization model may indicate and/or provide location information associated with the anomaly to the classification model and/or that may be used to generate anomaly data associated with the input image and/or object depicted in the input image.

As indicated above, FIG. 4 is provided as an example. Other examples may differ from what is described with regard to FIG. 4.

FIG. 5 is a diagram illustrating an example 500 of training and using a machine learning model in connection with image-based anomaly detection. The machine learning model training and usage described herein may be performed using a machine learning system. The machine learning system may include or may be included in a computing device, a server, a cloud computing environment, or the like, such as the object analysis system described in more detail elsewhere herein.

As shown by reference number 505, a machine learning model may be trained using a set of observations. The set of observations may be obtained from training data (e.g., historical data), such as data gathered during one or more processes described herein. In some implementations, the machine learning system may receive the set of observations (e.g., as input) from a reference data structure and/or the object management system (e.g., from an image capture device of the object management system), as described elsewhere herein.

As shown by reference number 510, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from a reference data structure and/or the object management system. For example, the machine learning system may identify a feature set (e.g., one or more features and/or feature values) by extracting the feature set from structured data (e.g., image data associated with images that depict non-anomalous objects), by performing an image processing technique to extract the feature set from unstructured data (e.g., image data associated with images that depict anomalous objects and non-anomalous objects), and/or by receiving input from an operator.

As an example, a feature set for a set of observations may include a first feature of contour data (e.g., a representation of a physical element or aspect of an object that may be identifiable in an image of the object), a second feature of pixel data (e.g., a red, green, blue (RGB) color value of pixels of the feature), a third feature of location data (e.g., coordinates identifying a location of the feature in the observation), and so on. As shown, for a first observation, the first feature may have a value of Contour_1 (e.g., an identifier of a feature type), the second feature may have a value of RGB_1 (e.g., a value of one or more pixels associated with the feature in the observation), the third feature may have a value of (X₁, Y₁) (e.g., a set of coordinates relative to a reference point of the object and/or coordinates relative to a reference point of the image of the observation, such as a reference image or an image captured by an image capture device), and so on. These features and feature values are provided as examples, and may differ in other examples. For example, the feature set may include one or more of the following features: size data (e.g., data representative of an area of the image that depicts the feature of the observation), shape data (e.g., data representative of a perimeter of the object), source data (e.g., data that identifies the source device associated with the observation), object type data (e.g., data that identifies a type of the object associated with the observation), object size data (e.g., data that identifies a size of the object), and so on.

As shown by reference number 515, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, or labels) and/or may represent a variable having a Boolean value. A target variable may be associated with a target variable value, and a target variable value may be specific to an observation. In example 500, the target variable is a feature type, which has a value of Feature_1 for the first observation and Feature_2 for the second observation. Feature_1 and/or Feature_2 may correspond to features of non-anomalous objects associated with an object type (e.g., because the machine learning model may be trained using reference images that depict non-anomalous objects). Correspondingly, the features (Feature_1 and Feature_2) may be associated with a reference object that the machine learning model is trained to identify and/or configure according to the observations.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 520, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 525 to be used to analyze new observations.

As shown by reference number 530, the machine learning system may apply the trained machine learning model 525 to a new observation, such as by receiving a new observation and inputting the new observation to the trained machine learning model 525. As shown, the new observation may include a first feature of Contour_N, a second feature of RGB_N, a third feature of (X_{N}, Y_{N}), and so on, as an example. The machine learning system may apply the trained machine learning model 525 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 525 may predict a value of Anomaly for the target variable of feature type for the new observation, as shown by reference number 535. For example, the target variable may indicate an Anomaly to indicate that the observation is associated with an anomalous object. The trained machine learning model 525 may predict the value of Anomaly when the feature set of the new observation cannot be mapped to a feature type that was learned when the machine learning model was trained. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation that a user of a user device address an anomaly on an object of the new observation and/or a recommendation to an object management system to manage the object based on including an anomaly (e.g., sort or remove the object from non-anomalous objects). The first automated action may include, for example, providing anomaly data to a user device to indicate that the object of the new observation includes an anomaly and/or causing an object management system to manage the object of the new observation based on including an anomaly (e.g., sort or remove the object from non-anomalous objects.

As another example, if the machine learning system were to predict a value associated with a learned feature for the target variable of feature type, then the machine learning system may provide a second (e.g., different) recommendation (e.g., recommendation to use or output the object or a recommendation to enable use or output of the object) and/or may perform or cause performance of a second (e.g., different) automated action (e.g., enable use or output of the object).

In some implementations, the trained machine learning model 525 may classify (e.g., cluster) the new observation in a cluster, as shown by reference number 540. The observations within a cluster may have a threshold degree of similarity. As an example, if the machine learning system classifies the new observation in a first cluster (e.g., a cluster associated with a first type of anomaly), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., a cluster associated with a second type of anomaly), then the machine learning system may provide a second (e.g., different) recommendation (e.g., recommend destroying or recycling the object if the second type of anomaly is a type that is irreparable) and/or may perform or cause performance of a second (e.g., different) automated action, such as destroying the object.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In this way, the machine learning system may apply a rigorous and automated process to detect and/or classify an anomaly associated with an object. The machine learning system enables recognition and/or identification of tens, hundreds, thousands, or millions of features and/or feature values for tens, hundreds, thousands, or millions of observations, thereby increasing accuracy and consistency and reducing delay associated with detecting and/or classifying an anomaly associated with object relative to requiring computing resources to be allocated for tens, hundreds, or thousands of operators to manually detect and/or classify an anomaly associated with an object using the features or feature values.

As indicated above, FIG. 5 is provided as an example. Other examples may differ from what is described in connection with FIG. 5.

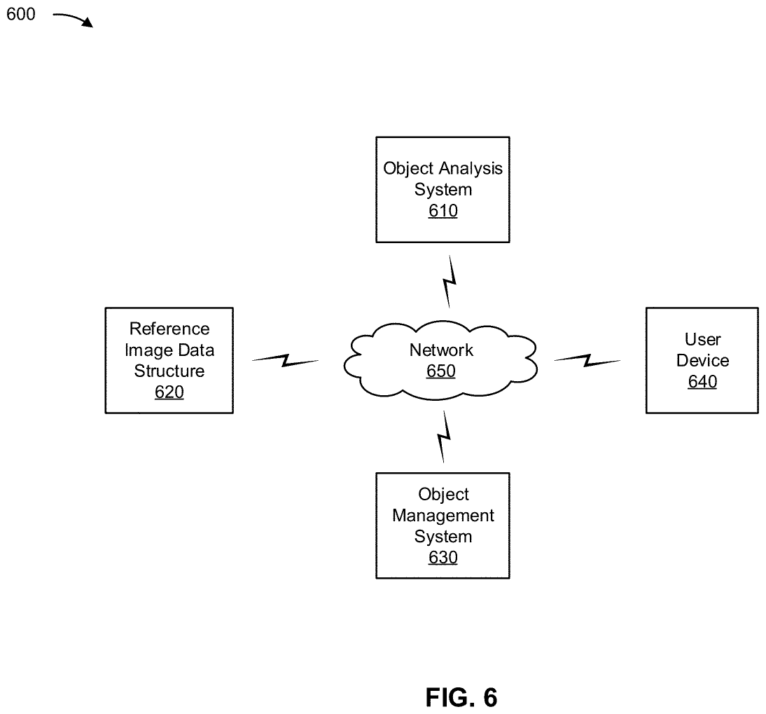

FIG. 6 is a diagram of an example environment 600 in which systems and/or methods described herein may be implemented. As shown in FIG. 6, environment 600 may include an object analysis system 610, a reference image data structure 620, an object management system 630, a user device 640, and a network 650. Devices of environment 600 may interconnect via wired connections, wireless connections, or a combination of wired and wireless connections.

The object analysis system 610 includes one or more devices capable of receiving, generating, storing, processing, providing, and/or routing information associated with image-based anomaly detection based on a machine learning analysis, as described elsewhere herein. The object analysis system 610 may include a communication device and/or a computing device. For example, the object analysis system 610 may include a server, such as an application server, a client server, a web server, a database server, a host server, a proxy server, a virtual server (e.g., executing on computing hardware), or a server in a cloud computing system. In some implementations, the object analysis system 610 includes computing hardware used in a cloud computing environment.

The reference image data structure 620 includes one or more devices capable of generating, storing, processing, and/or providing reference image data associated with one or more types of objects in order to train one or more models, as described elsewhere herein. For example, the reference image data structure 620 may include a storage device and/or a memory device that receives and/or stores reference images from one or more image sources. Additionally, or alternatively, the reference image data structure may include a communication device and/or a computing device for receiving, processing, and/or providing the reference image data to the object analysis system 610.

The object management system 630 includes one or more devices capable of receiving, generating, storing, processing, providing, and/or routing information associated with managing an object, as described elsewhere herein. For example, the object management system 630 may include one or more devices that are configured to facilitate assembly of one or more objects, manufacturing one or more objects, sorting one or more objects, distributing one or more objects, transporting one or more objects, and/or storing one or more objects. The object management system 630 may include a communication device, a computing device, a sensor, a robotic device, and/or any other suitable device of a control system associated with a particular industry (e.g., manufacturing, logistics, transportation, and/or other industries associated with supply chain management).

The user device 640 includes one or more devices capable of receiving, generating, storing, processing, and/or providing information associated with monitoring objects that are analyzed by the object analysis system 610 and/or managed by the object management system 630, as described elsewhere herein. The user device 640 may include a communication device and/or a computing device. For example, the user device 640 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 650 includes one or more wired and/or wireless networks. For example, the network 650 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 650 enables communication among the devices of environment 600.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

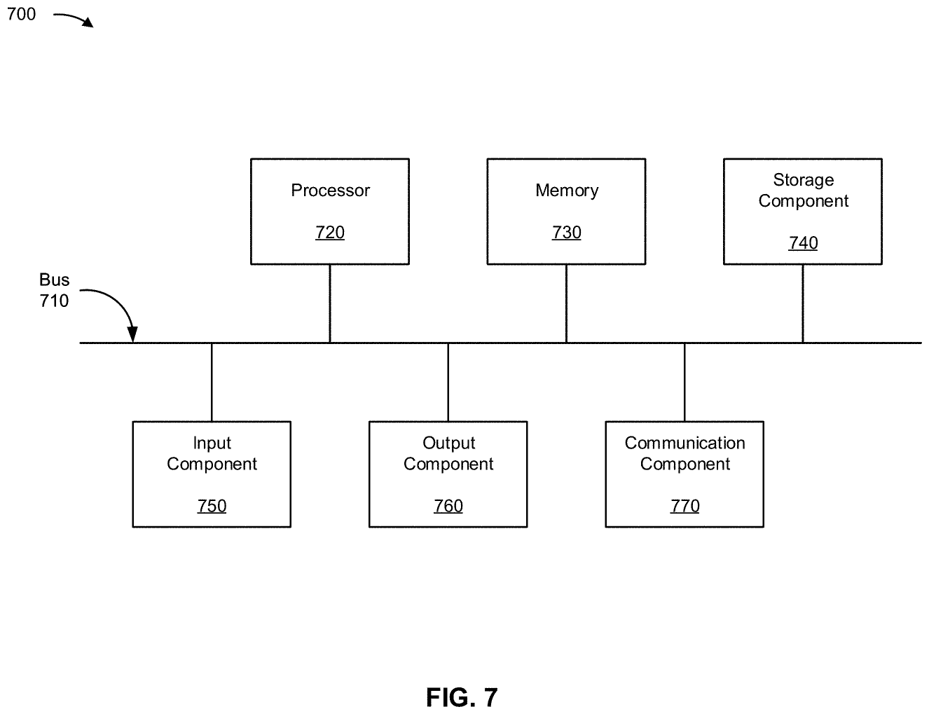

FIG. 7 is a diagram of example components of a device 700, which may correspond to the object analysis system 610, the reference image data structure 620, the object management system 630, and/or the user device 640. In some implementations, the object analysis system 610, the reference image data structure 620, the object management system 630, and/or the user device 640 may include one or more devices 700 and/or one or more components of device 700. As shown in FIG. 7, device 700 may include a bus 710, a processor 720, a memory 730, a storage component 740, an input component 750, an output component 760, and a communication component 770.

Bus 710 includes a component that enables wired and/or wireless communication among the components of device 700. Processor 720 includes a central processing unit, a graphics processing unit, a microprocessor, a controller, a microcontroller, a digital signal processor, a field-programmable gate array, an application-specific integrated circuit, and/or another type of processing component. Processor 720 is implemented in hardware, firmware, or a combination of hardware and software. In some implementations, processor 720 includes one or more processors capable of being programmed to perform a function. Memory 730 includes a random access memory, a read only memory, and/or another type of memory (e.g., a flash memory, a magnetic memory, and/or an optical memory).

Storage component 740 stores information and/or software related to the operation of device 700. For example, storage component 740 may include a hard disk drive, a magnetic disk drive, an optical disk drive, a solid state disk drive, a compact disc, a digital versatile disc, and/or another type of non-transitory computer-readable medium. Input component 750 enables device 700 to receive input, such as user input and/or sensed inputs. For example, input component 750 may include a touch screen, a keyboard, a keypad, a mouse, a button, a microphone, a switch, a sensor, a global positioning system component, an accelerometer, a gyroscope, and/or an actuator. Output component 760 enables device 700 to provide output, such as via a display, a speaker, and/or one or more light-emitting diodes. Communication component 770 enables device 700 to communicate with other devices, such as via a wired connection and/or a wireless connection. For example, communication component 770 may include a receiver, a transmitter, a transceiver, a modem, a network interface card, and/or an antenna.

Device 700 may perform one or more processes described herein. For example, a non-transitory computer-readable medium (e.g., memory 730 and/or storage component 740) may store a set of instructions (e.g., one or more instructions, code, software code, and/or program code) for execution by processor 720. Processor 720 may execute the set of instructions to perform one or more processes described herein. In some implementations, execution of the set of instructions, by one or more processors 720, causes the one or more processors 720 and/or the device 700 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 7 are provided as an example. Device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

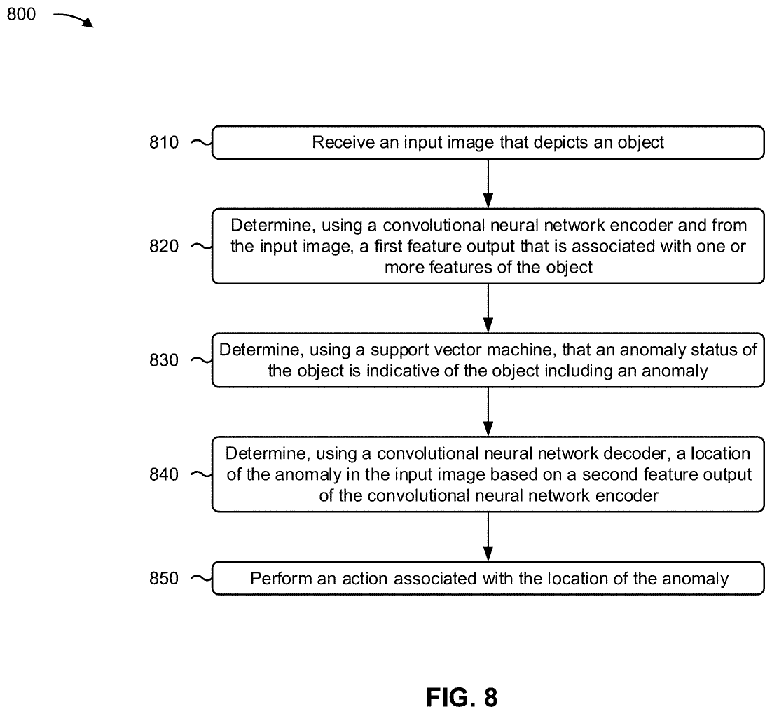

FIG. 8 is a flowchart of an example process 800 associated with image-based anomaly detection based on a machine learning analysis of an object. In some implementations, one or more process blocks of FIG. 8 may be performed by an object analysis system (e.g., the object analysis system 610). In some implementations, one or more process blocks of FIG. 8 may be performed by another device or a group of devices separate from or including the object analysis system, such as an object management system (e.g., the object management system 630), and/or a user device (e.g., the user device 640). Additionally, or alternatively, one or more process blocks of FIG. 8 may be performed by one or more components of device 700, such as processor 720, memory 730, storage component 740, input component 750, output component 760, and/or communication component 770.

As shown in FIG. 8, process 800 may include receiving an input image that depicts an object (block 810). For example, the object analysis system may receive an input image that depicts an object, as described above.

As further shown in FIG. 8, process 800 may include determining, using a convolutional neural network encoder and from the input image, a first feature output that is associated with one or more features of the object (block 820). For example, the object analysis system may determine, using a convolutional neural network encoder and from the input image, a first feature output that is associated with one or more features of the object, as described above. The convolutional neural network encoder may be associated with and/or included within a feature extraction model of the object analysis system.

In some implementations, the convolutional neural network encoder is trained based on reference images that depict reference objects that are a type of the object. The reference objects that are depicted in the reference images may be non-anomalous objects, as described herein.

As further shown in FIG. 8, process 800 may include determining, using a support vector machine, that an anomaly status of the object is indicative of the object including an anomaly (block 830). For example, the object analysis system may determine, using a support vector machine, that an anomaly status of the object is indicative of the object including an anomaly, as described above. In some implementations, the support vector machine is trained based on the reference images.

The support vector machine may be trained to determine a binary classification that indicates that the object includes an anomalous feature or that indicates that the object does not include an anomalous feature. The support vector machine may be trained to determine a classification threshold that is used to determine the binary classification based on a similarity analysis involving the reference images.

As further shown in FIG. 8, process 800 may include determining, using a convolutional neural network decoder, a location of the anomaly in the input image based on a second feature output of the convolutional neural network encoder (block 840). For example, the object analysis system may determine, using a convolutional neural network decoder, a location of the anomaly in the input image based on a second feature output of the convolutional neural network encoder, as described above. The convolutional neural network decoder may be associated with and/or included within an anomaly localization model of the object analysis system.

In some implementations, the convolutional neural network decoder is configured to determine the location of the anomaly based on a second feature output of the convolutional neural network encoder. In some implementations, the convolutional neural network decoder is trained based on the reference images. The first feature output may be from an output layer of the convolutional neural network encoder, and the second feature output may be from an intermediate layer of the convolutional neural network encoder. The convolutional neural network encoder and the convolutional neural network decoder may be associated with a same convolutional neural network autoencoder that is trained based on the reference images.

In some implementations, the object analysis system may generate anomaly data associated with the anomaly data. For example, the anomaly data may identify an anomaly status of the object (e.g., that the object includes or does not include an anomaly) and/or a location of an anomaly (if an anomaly is detected). Additionally, or alternatively, using an anomaly classification model, the anomaly data may be generated to indicate that the anomaly is a particular type of anomaly.

As further shown in FIG. 8, process 800 may include performing an action associated with the location of the anomaly (block 850). For example, the object analysis system may perform an action associated with the location of the anomaly, as described above. In some implementations, to perform the action, the object analysis system may generate a location indicator that identifies the location of the anomaly, combine the location indicator with the input image to form an anomaly indicator, and provide the anomaly indicator to a user device. Additionally, or alternatively, the object analysis system may provide anomaly data (e.g., to a user device) that identifies the location of the anomaly. The anomaly data may include a location indicator that identifies the location of the anomaly and/or a combination of the location indicator and the input image.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

In the foregoing disclosure, specific embodiments have been described. However, one of ordinary skill in the art will appreciate that various modifications and changes can be made without departing from the scope of the invention as set forth in the claims below. Accordingly, the specification and figures are to be regarded in an illustrative rather than a restrictive sense, and all such modifications are intended to be included within the scope of present disclosure. Additionally, the described embodiments/examples/implementations should not be interpreted as mutually exclusive, and should instead be understood as potentially combinable if such combinations are permissive in any way. In other words, any feature disclosed in any of the aforementioned examples or implementations may be included in any of the other aforementioned examples or implementations.

As used herein, the term “component” is intended to be broadly construed as hardware, firmware, and/or a combination of hardware and software. As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, or the like) on which machine-readable instructions (e.g., code in the form of, for example, software and/or firmware) can be stored. The instructions may be stored for any suitable duration of time, such as permanently, for an extended period of time (e.g., while a program associated with the instructions is executing), or for a short period of time (e.g., while the instructions are cached, during a buffering process, or the like). Further, as used herein, each of the terms “tangible machine-readable medium,” “non-transitory machine-readable medium” and “machine-readable storage device” is expressly defined to exclude propagating signals. That is, as used in any claim herein, a “tangible machine-readable medium,” a “non-transitory machine-readable medium,” and a “machine-readable storage device,” or the like, should not be interpreted as being implemented as a propagating signal.

As used herein, satisfying a threshold may, depending on the context, refer to a value being greater than the threshold, greater than or equal to the threshold, less than the threshold, less than or equal to the threshold, equal to the threshold, not equal to the threshold, or the like.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, as used herein, relational terms such as first and second, top and bottom, or the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element.

The terms “a” and “an” are defined as one or more unless explicitly stated otherwise herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

The abstract of the disclosure is provided to allow the reader to quickly ascertain the nature of the technical disclosure. It is submitted with the understanding that it will not be used to interpret or limit the scope or meaning of the claims. In addition, in the foregoing description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A method associated with detecting an anomaly associated with an object, comprising:
receiving, by a device, an input image that depicts the object;
processing, by the device and using a feature extraction model, the input image to indicate one or more features of the object in a first feature output,
wherein the feature extraction model is trained based on reference images associated with a type of the object,
wherein the reference images depict one or more non-anomalous objects that are of a same type as the type of the object;
determining, by the device and based on the one or more features, using a classification model, that an anomaly status of the object indicates that the object includes an anomaly,
wherein the classification model is configured to determine the anomaly status based on a classification score associated with the first feature output and a classification threshold of the classification model,
wherein the classification threshold is determined based on a similarity analysis involving the reference images;
determining, by the device, a location of the anomaly associated with the anomaly status based on a second feature output of the feature extraction model,
wherein the location of the anomaly is determined using an anomaly localization model that is trained based on the reference images;
generating, by the device and based on the anomaly status and the location, anomaly data that is associated with the anomaly; and
providing, by the device and to an object management system, the anomaly data.

2. The method of claim 1, wherein the classification model includes a support vector machine that is configured to:
determine the classification score based on the first feature output; and
indicate the anomaly status based on a comparison of the classification score and the classification threshold,
wherein the support vector machine is a single class support vector machine that is specifically trained to analyze the type of the object, and
wherein the anomaly status is a binary classification that is determined based on the comparison and is indicative of the object having an anomalous feature or is indicative of the object not having an anomalous feature.

3. The method of claim 1, wherein the classification model comprises:
a first support vector machine that is configured to output a first binary classification according to the classification threshold,
wherein the first binary classification is indicative of the object including an anomalous feature, and
a second support vector machine that is configured to output, based on the first binary classification indicating that the object includes an anomalous feature, a second binary classification that indicates that the anomaly is a particular type of anomaly or that the anomaly is not the particular type of anomaly,
wherein the anomaly data is generated to include, based on the second binary classification, a label that indicates that the anomaly is the particular type of anomaly or that the anomaly is not the particular type of anomaly.

4. The method of claim 1, wherein the first feature output is from an output layer of a convolutional neural network encoder of the feature extraction model, and
wherein the second feature output is from an intermediate layer of the convolutional neural network encoder.

5. The method of claim 1, wherein the anomaly localization model comprises a convolutional neural network decoder that is configured to determine the location of the anomaly.

6. The method of claim 5, wherein the second feature output is from an intermediate layer of a convolutional neural network encoder of the feature extraction model.

7. The method of claim 1, wherein generating the anomaly data comprises:
generating a location indicator that identifies the location of the anomaly; and
combining the location indicator with the input image.

8. A device, comprising:
one or more memories; and
one or more processors, coupled to the one or more memories, configured to:
receive an input image that depicts an object;
process, using a feature extraction model, the input image to generate a first feature output that is associated with one or more features of the object,
wherein the feature extraction model is trained based on reference images associated with a type of the object;
determine, using a classification model, an anomaly status of the object based on the first feature output,
wherein the classification model is trained to determine the anomaly status based on a similarity analysis involving non-anomalous objects depicted in the reference images;
determine, based on the anomaly status indicating that the input image depicts the object having an anomaly, a location of the anomaly in the input image based on a second feature output of the feature extraction model,
wherein the location of the anomaly is determined using an anomaly localization model that is trained based on the reference images;
generate, based on the anomaly status and the location, anomaly data that is associated with the anomaly; and
perform an action associated with the anomaly data.

9. The device of claim 8, wherein the feature extraction model comprises a convolutional neural network encoder.

10. The device of claim 8, wherein the classification model comprises a support vector machine that is configured to provide a classification score that is indicative of the object including an anomalous feature or not including an anomalous feature,
wherein the anomaly status is configured to indicate that the input image depicts the object having the anomaly based on the classification score being indicative of the object including an anomalous feature.

11. The device of claim 10, wherein the similarity analysis is configured to determine a classification threshold of the support vector machine that is compared with the classification score to determine a binary classification of the anomaly status that is associated with the object including an anomalous feature or not including an anomalous feature.

12. The device of claim 8, wherein the first feature output and the second feature output are from different layers of a convolutional neural network of the feature extraction model.

13. The device of claim 8, wherein the one or more processors, to generate the anomaly data, are configured to:
generate a location indicator that identifies the location of the anomaly; and
combine the location indicator with the input image.

14. The device of claim 8, wherein the one or more processors, to perform the action, are configured to at least one of:
transmit, to a user device, the anomaly data, or
control, according to the anomaly data, an object management system to perform an operation associated with the object.

15. A tangible machine-readable medium storing a set of instructions, the set of instructions comprising:
one or more instructions that, when executed by one or more processors of a device, cause the device to:
receive an input image that depicts an object;
determine, using a convolutional neural network encoder and from the input image, a first feature output that is associated with one or more features of the object,
wherein the convolutional neural network encoder is trained based on reference images that depict reference objects that are a type of the object;
determine, using a support vector machine, that an anomaly status of the object is indicative of the object including an anomaly,
wherein the support vector machine is trained based on the reference images;
determine, using a convolutional neural network decoder, a location of the anomaly in the input image based on a second feature output of the convolutional neural network encoder,
wherein the convolutional neural network decoder is configured to determine the location of the anomaly based on a second feature output of the convolutional neural network encoder, and
wherein the convolutional neural network decoder is trained based on the reference images; and
perform an action associated with the location of the anomaly.

16. The tangible machine-readable medium of claim 15, wherein the reference objects that are depicted in the reference images are non-anomalous objects.

17. The tangible machine-readable medium of claim 15, wherein the support vector machine is trained to determine a binary classification that indicates that the object includes an anomalous feature or that indicates that the object does not include an anomalous feature,
wherein the support vector machine is trained to determine a classification threshold that is used to determine the binary classification based on a similarity analysis involving the reference images.

18. The tangible machine-readable medium of claim 15, wherein the first feature output is from an output layer of the convolutional neural network encoder, and
wherein the second feature output is from an intermediate layer of the convolutional neural network encoder.

19. The tangible machine-readable medium of claim 15, wherein the convolutional neural network encoder and the convolutional neural network decoder are associated with a same convolutional neural network autoencoder that is trained based on the reference images.

20. The tangible machine-readable medium of claim 15, wherein the one or more instructions, that cause the device to perform the action, cause the device to:
generate a location indicator that identifies the location of the anomaly;
combine the location indicator with the input image to form an anomaly indicator; and
provide the anomaly indicator to a user device.
